(19) United States
(12) Patent Application Publication
(10) Pub. No.: US 2011/0045160 A1
(43) Pub. Date: Feb. 24, 2011

(54) SATIETY INDUCING FOOD COMPOSITION

(75) Inventors: Giuseppe Battaini, Konstanz (DE); Ramona Fezer, Singen (DE); Sophie Lagarrigue, Konstanz (DE); Jane Hilary Green, Chatillens (CH); Alfrun Erkner, Lausanne (CH); Alison L. Eldridge, Pully (CH)

Correspondence Address: K&L Gates LLP, P.O. Box 1135, CHICAGO, IL, 60690, US

(73) Assignee: NESTEC S.A., Vevey (CH)

(21) Appl. No.: 12/990,581

(22) PCT Filed: Apr. 7, 2009
(86) PCT No.: PCT/EP09/54123

§ 371 Date: Nov. 1, 2010

(30) Foreign Application Priority Data
Apr. 30, 2008 (EP) 08155424.8

(51) Int. Cl. A23L 1/305; A23P 1/00; A23J 1/20; A23L 1/212; A23L 1/10; A23L 1/20; A23L 1/39; A23L 2/66; A23J 1/02; A23L 1/308

(52) U.S. Cl. 426/580; 426/656; 426/615; 426/618; 426/634; 426/589; 426/590; 426/657

(57) ABSTRACT

The present invention relates to a method for preparing a satiety inducing food composition based on a dry food powder composition which upon reconstitution in a liquid, e.g. water, and subsequent consumption, induces satiety. The resulting food compositions have an optimised combination of protein and fibres, consistency, energetic value which together promote an optimised fullness sensation upon consumption. The present invention thus also relates to the use of the dry food powder for the preparation of a satiety inducing food composition.

### FIELD OF THE INVENTION

The present invention relates to a method for preparing a satiety inducing food composition based on a dry food powder composition which upon reconstitution in a liquid, e.g. water, and subsequent consumption, induces satiety. The resulting food compositions have an optimised combination of protein and fibres, consistency, energetic value which together promote an optimised fullness sensation upon consumption. The present invention thus also relates to the use of the dry food powder for the preparation of a satiety inducing food composition.

### BACKGROUND OF THE INVENTION

In the context of health and weight management, a number of approaches have been suggested to increase the fullness sensation upon consumption of food.

An approach consists in providing compositions comprising proteinase inhibitors which stimulate secretion of cholecystokinin. Indeed cholecystokinin levels are known to have an enhancing effect on satiety. Such approach is described for example in WO 0117541, WO 0247614, WO 0162086, WO 2004002241, US 20040077530, WO2004034813.

Compositions comprising “gel-formers” or swelling agents in the stomach to increase satiety have also been described for example in WO 0219842 and WO 200520719. Pharmacological appetite-reducing agents, e.g. drugs which influence neurotransmitter levels in the brain have also been developed.

A number of ingredients have been identified as increasing the satiety impression. These include proteins, such as whey protein, whey protein hydrolysates, fibres, fatty acids.

Thus, many food compositions which may be used for satiety purposes have been developed. Such food compositions are disclosed for example in U.S. Pat. No. 5,688,547, WO 0296219, WO 200523017, WO 2004068972, WO 2006065738, WO 2007044511, WO 2006134159.

Due to low caloric density and the solid inclusions semi-liquid food matrices like soups are an ideal candidates to develop satiety inducing food compositions.

In food compositions, there are several important factors for inducing satiety. Energy, volume, solid inclusions, texture, protein and fiber are generally considered the most effective. For developing satiety inducing food compositions aimed for weight management the main goal is to maximize the satiety impact optimizing the synergic effects of volume, solid inclusions, texture, protein and fiber for minimizing the energetic contribution.

In fact, when these elements are used singularly for inducing a physiologically relevant satiety benefit they are used at high dosage which is detrimental to the product sensory attributes and organoleptic properties. For example high protein and fibre amounts are difficult to incorporate into dry food compositions due to technological constraints.

### OBJECT OF THE INVENTION

It is thus an object of the invention to provide a food composition from a dry powder mix where, within the particular food matrix constraints, the formulation parameters which induce the satiety sensation have been synergically optimized. In this way, this food composition can maintain a balanced nutritional profile and excellent organoleptic properties.

### SUMMARY OF THE INVENTION

This object is solved by the present independent claims. The dependent claims further develop the central idea of the invention.

Thus, the present invention provides in a first aspect a method for preparing a satiety inducing food composition, comprising the step of mixing 50-100 g of a dry powder food composition with 300-500 mL of water, wherein the macronutrients final food composition comprises 14-18 g protein, 2.5-6.5 g fibres of which 15-90% are viscous fibres, 20-40 g inclusions and has a caloric content of at least 250 kcal.

In a second aspect, the present invention pertains to a dry food powder composition comprising

17-30 wt % protein,
3-11 wt % fibre of which 15 to 90% of the fibres are viscous fibres,
30-50 wt % inclusions,
wherein the dry food powder composition has a caloric value of at least 310 kcal/100 g.

The use of a dry powder according to claim 12 or 13, in the preparation of a satiety inducing food composition also forms part of the present invention.

### SHORT DESCRIPTION OF THE FIGURES

FIG. 1 represents a graph showing the experimental results for clinical testing of the effect of different amounts of proteins and fibre on satiety.

### DESCRIPTION OF THE INVENTION

The present invention relates in a first aspect to a method for preparing a satiety inducing food composition. Satiety is a physiological response which can be assessed according to methods known to the skilled person and described for example in Am. J. Clin. Nutr 76:1023-1030 (2002).

The method involves the step of mixing 50-100 g of a dry powder food composition with 300-500 mL of water. Preferably the amount of dry powder food composition is 60-80 g. These values typically provide one portion for consumption. The food composition obtained upon reconstitution is characterised in that it comprises 14-18 g of protein, 2.5-6.5 g of fibres of which 15-90% are viscous fibres, 20-40 g of inclusions and has a caloric content of at least 250 kcal.

The level of protein is important in order to achieve the desired effect on satiety. However, the level of protein alone is not sufficient to achieve the optimised effect of the present invention.

The protein may be selected from any natural source such as milk powder, skim milk powder, milk proteins, meat proteins, legume protein, cereal protein, meat or fish protein hydrolysates, whey protein, caseinates, casein glycomacropeptides.

The total protein content may be assessed by known methods such as by measurement of the total nitrogen (e.g. ISO method).

Regarding the fibres, preferably 15-50% of the fibres are viscous fibres, more preferably 20-40% are viscous fibres. By viscous fibres is meant fibres which contribute to the viscosity of the food composition before consumption and/or in the gastrointestinal tract.

The fibre sources, viscous or non-viscous, may be selected from vegetables, whole cereals such as barley, oat etc., legumes such as peas, gums such as guar gum, acacia gum and inulins, and any mixtures thereof. The viscous fibres present in the compositions of the present invention may comprise any of beta-glucans, guar gum, pectins, locust bean gum or any mixtures thereof.

The total fibre content may be assessed by methods known in the art such as the method AOAC 985.29, whereby specific fibre content can be assessed by other method such as AOAC 995.16.

Surprisingly, it has been found that, contrary to the general trend, increasing the fibre level in the food composition from 2.5 g to above 6.5 g did not improve satiety. Thus, an optimal fibre amount has been found which provides an optimised satiety impact and a balanced food composition when combined with the other ingredients of the composition.

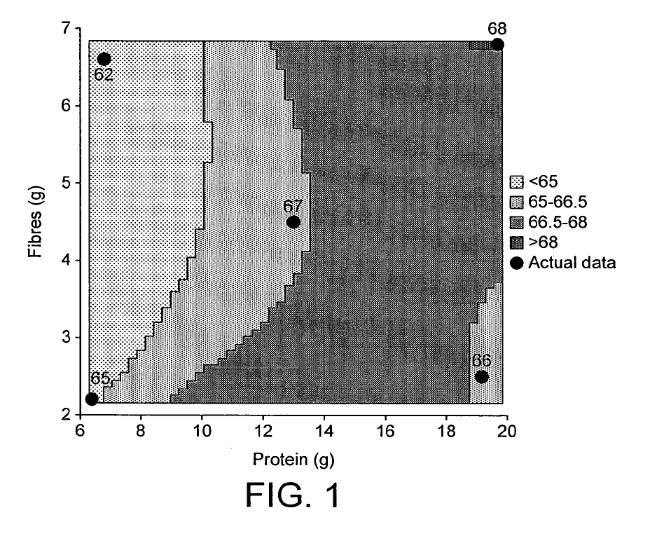

This is reflected in FIG. 1 showing the best satiety score for the 14-18 g protein content and 2.5 to 6.5 g fibre content.

In the food composition obtained by the method of the invention, the protein and fibre components may be provided by the same source. Indeed, ingredients such as bean, meat, pulses, wholemeal pasta and/or cereal may provide both the protein and fibre components. These ingredients may also contribute to the carbohydrate and lipid content of the composition.

The food composition may comprise further ingredients selected from carbohydrates, lipids, enhancing taste agents, flavouring agents, or mixtures thereof.

The fat may be provided by oils, creamer, vegetable or animal fats, cream and any traditional ingredients used in the manufacture of dehydrated food compositions. Carbohydrates may be provided by sugars, starches, flours, maltodextrins etc.

Furthermore, the reconstituted food composition of the invention has a caloric value of at least 250 kcal. This caloric value corresponds to a portion. A portion is obtained by reconstituting 50-100 g of dry powder in 300-500 mL of water according to the method of the invention. This lower limit ensures that a physiologically relevant satiety is achieved in an optimised way when combined with all other features of the composition. This value is higher than traditional satiety promoting products. However, it has been found to be necessary in order to achieve the optimised satiety effect.

Another factor necessary for an optimised satiety effect is the presence of inclusions. The food composition obtained by the method of the invention thus comprises 20-40 g inclusions. By inclusions are meant particles having a larger dimension than the powder particles used for preparing the satiety inducing food composition. The inclusions may contribute to the overall protein, fibre, carbohydrate or fat content of the dry food composition.

The inclusions also contribute to the satiety feeling when consumed. In addition to the content of the inclusions, which may include macronutrients such as fibres, proteins, fats, carbohydrates etc., it has been found that the size of the inclusions is also important. Indeed, the act of having to chew on the inclusions increases the satiety effect. Thus, when the powder of the invention is reconstituted in water, these inclusions preferably have a dimension of at least 1 cm, more preferably at least 1.5 cm.

Inclusions may be selected from pasta, dumplings, croutons, vegetable pieces etc.

Consistency has been found to be a factor which also affects the satiety effect of the products of the invention.

Therefore, in a preferred embodiment, the reconstituted product is characterised by a viscosity of the liquid phase between 80 and 500 mPa·s at a shear rate of 50 s⁻¹, when measured at a temperature of 60° C. The viscosity is measured without inclusions. This provides the reconstituted food composition with a creamy to thick consistency which may also contribute to the satiety effect. Preferably, the viscosity is between 90 and 200 mPa·s at a shear rate of 50 s⁻¹, when measured at a temperature of 60° C.

According to an alternative aspect of the invention, the rehydrated food composition has a liquid phase having a very low viscosity, i.e. less than 80 mPa·s at a shear rate of 50 s⁻¹ when measured at a temperature of 60° C. Again, the viscosity measured is that of the liquid phase without inclusions. Such viscosity is typically characteristic of a clear broth, for example. In this case, the food composition, which is preferably a soup, preferably contains at least 25 g of inclusions such that the fullness effect is still present.

The viscosity of the liquid phase is characterised with a MCR300 from Anton Paar equipped with a bob and cup geometry (measuring cup diameter: 29 mm, concentric cylinder diameter and length: respectively 27 and 40 mm). The measurements are performed at a temperature of 60° C. After cooking, the sample is placed in the rheometer cup preheated at 60° C. and after 5 min equilibration time, the apparent viscosity is measured at different shear rates increasing from 0.1 to 500 s⁻¹. The value of the viscosity at a shear rate of 50 s⁻¹ is extracted from the flow curve.

Typically, the reconstituted product is a soup, drink, or sauce. Preferably, it is a soup. More preferably it is a hot soup. By hot is meant that the soup has a temperature above 50° C.

The present invention also relates to a dry food powder composition. Preferably, the dry powder is a soup composition. Thus, upon water addition, the food composition is a soup. However, the dry powder composition may also be used in the preparation of dairy foods, prepared meals, cereal products, drinks, sauces etc.

The powder of the invention comprises 17-30 wt % protein. Preferably, it comprises 20-25 wt % protein. The powder of the invention also comprises 3 to 11 wt % fibres of which 15 to 90% are viscous fibres. Preferably it comprises 3-6 wt % fibres of which 15 to 90% are viscous fibres.

Furthermore, the powder comprises 30 to 50 wt % of inclusions and has a caloric value of at least kcal/100 g.

The powder may further comprise 30-80 wt % of further ingredients selected from carbohydrates, lipids, enhancing taste agents, flavouring agents or mixtures thereof. Typically, it comprises 2-30 wt % fat, preferably 5-15 wt % of fat, and 30-80 wt %, preferably 45-75 wt % carbohydrates.

Such powder may be used according to the invention in the preparation of a satiety inducing food composition.

Thus, in a further aspect, the present invention is also concerned with the use of a dry powder in the preparation of a satiety inducing food composition. Preferably, the satiety inducing food composition is prepared by mixing 50-100 g, preferably 60-80 g of the dry powder of the invention with at 300-500 mL of a liquid. Preferably the liquid is water. More preferably the liquid is hot water, i.e. water above 50° C. Preferably, the powder is mixed with the water and subsequently cooked for 5 minutes before being consumed. Alternatively, the water may be heated first and the powder may be added to the hot water, cooked for 5 minutes and served.

The resulting food composition may be a soup, a sauce or a drink. Preferably, it is a soup.

It has now been found that the satiating capacities of foods such as soups can be influenced by various factors such as caloric content, volume (serving size), texture, physical properties and macronutrient composition, especially proteins and fibres.

The advantages presented by the products of the invention are that they may be used as satiety inducing compositions, while still having good organoleptic properties despite the high content of protein and fibre. They may easily be manufactured in powder form and are easily reconstituted in cold or hot liquids. They also offer a nutritionally balanced profile. Due to the synergistic combination of factors such as macronutrients, nutritional profile, texture and consistency of the reconstituted food composition, an optimised satiety impact can be achieved as well as a nutritionally balanced food product.

### EXAMPLES

### Example 1

### Clear Soup

A typical list of ingredients in the preparation of a soup containing pasta and dumplings inclusions is given below.

| Ingredients | % |
|---|---|
| Salt, spices, flavours, | 6 |
| herbs | |
| Fat | 7 |
| Starches, flours | 2 |
| Maltodextrin | 31 |
| Pasta and dumplings | 40 |
| Milk and animal protein | 10 |
| Vegetable powder and pieces | 4 |

### Example 2

### Creamy Soup

| Ingredients | % |
|---|---|
| Salt, spices, flavours, | 9 |
| herbs | |
| Fat, cream | 7 |
| Starches, flours | 1 |
| Maltodextrin | 8 |
| Pasta and dumplings | 30 |
| Milk and animal protein | 16 |
| Vegetable powder and pieces | 29 |

### Example 3

### Comparative Examples of Soups Having Varying Amounts of Protein and Fibres

The level of protein and fibre of soups was varied and the impact on satiety was measured.

| | Weight | Protein | Fibre | Water |
|---|---|---|---|---|
| Soups | (g) | (g) | (g) | (g) |
| HP:HF | 368 | 19.7 | 6.8 | 300 |
| HP:LF | 362 | 19.2 | 2.5 | 300 |
| MP:MF | 364 | 13.0 | 4.5 | 300 |
| LP:HF | 366 | 6.8 | 6.6 | 300 |
| LP:LF | 361 | 6.4 | 2.2 | 300 |

HP: high protein
HF: high fibre
MP: medium protein
MF: medium fibre
LP: low protein
LF: low fibre

The soups were isocaloric and had a value of above 250 kcal.

The soups were prepared by mixing with water and cooking for 3 minutes.

The soups were then kept at a temperature between 65 and 75° C. and eaten by volunteers. A composite satiety score (CSS) showing the satiety capacities of foods based on the appetite VAS (Visual Analog Scores) scores described by Anderson, G. H. et al. in Am. J. Clin. Nutr 76:1023-1030 (2002) was calculated according to the following:

$$CSS = \frac{\begin{matrix}Fullness + ( 100 - Desire to Eat ) + \\ ( 100 - Hunger ) + ( 100 - PFC )\end{matrix}}{4}$$

The CSS ranges from 0 to 100 with 0 indicating maximum appetite sensations and 100 indicating maximum satiety sensations.

A mathematical modelling of the results was performed and the analysis shows that highest satiety ratings for a soup having 14-18 g of protein and 2.5-6.5 g of fibre (cf. FIG. 1).

These results have been refined by an additional study where isocaloric soup samples have been tested following the same methodology. Fullness, Hunger, Desire to Eat, Prospective Consumption, Thirst and Liking ratings were collected using Visual Analog Scales (VAS).

Nutrients per Serving

| | Satiety- | |
|---|---|---|
| | optimized soup | Control Soup |
| Protein (g) | 16.7 | 3.7 |
| Fiber (g) | 4.9 | 1.9 |
| Inclusions >1.5 | 20 | 0 |
| cm (g) | | |
| Texture viscosity | >90 mPa · s | <90 mPa · s |
| (50 s⁻¹, 60° C.) | | |

Statistically significant differences in Fullness were reported for the satiety-optimized soup for 90 min post-consumption. Mean differences in VAS scores was −6.5 (p=0.0468).

These results have been confirmed by an additional study where non isocaloric soup samples have been tested following the same approach.

Nutrients per Serving

| | Satiety- | |
|---|---|---|
| | optimized soup | Control Soup |
| Energy | 250 | 90 |
| Protein (g) | 14.4 | 1.9 |
| Fiber (g) | 4.9 | 1.4 |
| Inclusions >1.5 | 20 | 0 |
| cm (g) | | |
| Texture viscosity | >90 mPa · s | <90 mPa · s |
| (50 s⁻¹, 60° C.) | | |

Statistically significant differences in all the satiety markers were reported for the satiety-optimized soup for 240 min post-consumption. For instance for fullness, there was a significant difference in VAS scores between the two treatments (mean difference was −8.62) with a large effect (0.226, P<0.005, effect size as measured by SPSS Partial Eta Squared value).

1. Method for preparing a satiety inducing food composition, comprising the steps of mixing at least 50-100 g of a dry powder food composition with 300-500 mL of water, the macronutrients of a final food composition comprising 14-18 g protein, 2.5-6.5 g fiber of which 15-90% are viscous fibers, 20-40 g inclusions and the final food composition having a caloric content of at least 250 kcal.

2. Method according to claim 1, wherein the protein is selected from the group consisting of milk powder, skim milk powder, milk proteins, meat proteins, legume proteins, cereal protein, meat or fish protein hydrolysates, whey protein, caseinates, and casein glycomacropeptides.

3. Method according to claim 1, wherein the fibers are selected from the group consisting of vegetables, whole cereals, legumes, gums, acacia gum and inulins and mixtures thereof.

4. Method according to claim 1, wherein the viscous fibers are selected from the group consisting of beta-glucans, guar gum, pectins, locust bean gum and mixtures thereof.

5. Method according to claim 1, wherein the inclusions are selected from the group consisting of pasta, dumplings, croutons, and vegetable pieces.

6. Method according to claim 1, wherein the inclusions have a dimension of at least 1 cm.

7. Method according to claim 1, wherein the food composition has a liquid phase having a viscosity of between 80 and 500 mPa·s at a shear rate of 50 s⁻¹ at 60° C.

8. Method according to claim 1, wherein the food composition is selected from the group consisting of a soup, a sauce, and a drink.

9. Method according to claim 1, wherein the water is at ambient temperature.

10. Method according to claim 9, wherein the food composition is heated to a temperature of 50-100° C. prior to consumption.

11. Dry food powder composition comprising
17-30 wt % protein;
3-11 wt % fiber of which 15 to 90% of the fibers are viscous fibres;
30-50 wt % inclusions; and
the composition has a caloric value of at least 310 kcal/100 g of powder composition.

12. Dry food powder composition according to claim 11, comprising 30-80 wt % of further ingredients selected from the group consisting of carbohydrates, lipids, enhancing taste agents, flavouring agents and mixtures thereof.

13. Dry food powder composition according to claim 11 comprising 2-30 wt % fat and 45-75 wt % carbohydrates.

14. A method for preparing a food product comprising the steps of:
mixing 50 to 100 g of a powder comprising 17-30 wt % protein; 3-11 wt % fiber of which 15 to 90% of the fibers are viscous fibres; 30-50 wt % inclusions; and the composition has a caloric value of at least 310 kcal/100 g of powder composition with 300-500 mL of water, to prepare a satiety inducing food composition selected from the group consisting of a soup, a sauce, and a drink.

15. Method of claim 1 wherein the protein is from a natural source.

16. Method according to claim 1 wherein the water is at a temperature of between 50-100° C.
